(19) United States
(12) Patent Application Publication
(10) Pub. No.: US 2015/0245588 A1
(43) Pub. Date: Sep. 3, 2015

(54) 100% Biodegradable/Compostable Pet Litter System or Kit

(71) Applicants: David Charles Perorazio, Powell, OH (US); Alexander David Perorazio, Powell, OH (US); Lee Ann Perorazio, Powell, OH (US); Daniel Robert Perorazio, Powell, OH (US)

(72) Inventors: David Charles Perorazio, Powell, OH (US); Alexander David Perorazio, Powell, OH (US); Lee Ann Perorazio, Powell, OH (US); Daniel Robert Perorazio, Powell, OH (US)

(21) Appl. No.: 13/481,651

(22) Filed: May 25, 2012

Related U.S. Application Data
(60) Provisional application No. 61/490,271, filed on May 26, 2011.

(51) Int. Cl. A01K 1/01

(52) U.S. Cl. CPC A01K 1/0107; A01K 1/0114

(57) ABSTRACT

The invention provides a 100% biodegradable/compostable pet litter system that is self-contained for proper care, maintenance and disposal of pet waste. The kit is designed to include a false floor system to allow contaminated litter to sift through the floor and away from the pet after each use. The kit contains a design for sealing and transporting along with disposable waste bags and scooper for solid waste removal. The kit contains storage for bags and scooper when not in use. The kit incorporates 100% biodegradable litter such as pine pellets, corn, paper or other biodegradable litter. The kit is manufactured from 100% biodegradable materials such a fiberboard or any material which can breakdown in a landfill in as little as 2 months but no longer than 12 months.

### CROSS REFERENCE TO RELATED APPLICATION

This application claims the benefit of U.S. Provisional Application No. 61/490,271 filed May 26, 2011

### SUMMARY OF THE INVENTION

### Brief Description of the Invention

This present invention provides for the development and manufacture of a 100% biodegradable/compostable litter kit. A 100% biodegradable/compostable kit in this invention refers to the complete requirements to properly care and maintain a pet litter box which includes litter containment box, soiled litter separation partition (false bottom), biodegradable/compostable litter, soiled litter removal device and soiled litter containment bags for daily waste removal from the litter box. This invention provides the pet owner the benefit of a 100% green solution for proper pet hygiene along with safe environmental disposal for the entire pet litter kit.

### DEFINITIONS, TERMS, ELEMENTS

100% Biodegradable/Compostable—refers to the complete litter kit that can be broken down naturally in the span of 9 months or less. Biodegradable items are those that diminish without causing harm to the environment or causing harm to our health.

Litter Kit—refers to the needed tools and containers to properly maintain a pet litter box—this would include the litter box, litter, any separation device to remove soiled litter away from unsoiled cat litter, litter scoop for removal of soiled litter and disposal containers (bags or other device) for dispose of daily waste from the litter box.

Litter containment box—refers to a disposable litter containment box designed to hold biodegradable litter and used on a daily basis for pet bathroom.

Soiled litter separation partition or (false bottom)—refers to a separator insert between the usable pet litter and the floor of the pet litter box to allow soiled waste from the pet urine to drop through the false floor, away from the pet and the remaining clean litter to assure that the pet is always is using clean litter.

Biodegradable/Compostable litter—refers to any all natural litter to be used in conjunction with a litter kit that is also 100% biodegradable/compostable.

Soiled litter removal device—refers to a scoop or small shovel used to remove soiled and solid waste from the litter box

Soiled litter containment bags—refers to waste containment bags for daily removal of soiled and solid waste from the litter box

100% green solution—refers to the use of a pet litter system or kit which promotes the utilization of all pet litter system or kit components that are non-harmful to the environment and minimize the contribution of additional pollutants to landfills and the environment.

### BACKGROUND OF THE INVENTION

b 1. Field of the Invention

This invention relates to a disposable pet litter system or kit and more particular that all components of the system or kit are 100% biodegradable/compostable. The pet litter system or kit would provide a biodegradable pet litter container with biodegradable litter and includes a biodegradable scooper and biodegradable solid waste disposal bags for proper daily care of the pet litter box. Materials used to provide moisture resistant properties for the disposable litter box must also be made from biodegradable materials.

2. Background Information

Pet litter and the proper maintenance of the litter box is an important aspect of pet ownership but also one of the most frustrating. According to the American Pet Products Association (APPA) Survey for 2011-2012, 62% of U.S. households own a pet, which equates to 72.9 million homes and this trend continues to grow. Cats have surpassed dogs as to the number of pets per household. The APPA reports that there are 86.4 million cats owned in America versus 78.2 million dogs.

The average cat owner spends approximately $165 per pet per year on litter. We are currently dumping most of this non-biodegradable litter in our landfills at a rate of 2 million tons per year. This volume of waste does not include numerous other non-biodegradable items such as old plastic litter containers; plastic bags filled with soiled litter and plastic litter scoopers along with numerous other plastic accessories.

The process of cleaning out the litter box with various cleaners and chemicals along with the disposal of these cleaners into our water supply adds to the problem of environmental impact. Most pet owners desire to provide a green solution for their pet's toiletry system and minimizing the impact on the environment but currently there is no complete solution.

Disposable litter containers have numerous designs and concepts, as any patent search of the U.S. Patent Office will provide. Many of this designs and inventions provide the user a relatively simple way to dispose of litter containers while avoiding the mess of dumping an used litter, cleaning the litter box and refilling the box with fresh litter.

These disposable litter-containers have taken many shapes and forms and have incorporated a variety of materials, some claiming to be biodegradable and others simply claiming the convenience of a disposable litter box. The problem with most of this litter boxes is that they do not provide the pet owner a complete 100% biodegradable/compostable solution for litter maintenance. Many of these designs and inventions have the following disadvantages:
1. Designed for use with non-biodegradable/compostable litter
2. Pre-filled with granular clay based or silica litter
3. Lack of sufficient litter and depth for extended use
4. Limited to disposable litter container only—no option for scooper or waste bags
5. Litter container is non-biodegradable/compostable
6. No separation layer or false floor to remove soiled litter from clean litter and away from pet
7. Litter kit does not provide a 100% biodegradable/compostable solution for the scooper
8. Litter kit does not provide a 100% biodegradable/compostable solution for daily solid waste disposal by the way of disposable bags
9. Inadequate strength of litter box for shipment
10. Does not contain a moisture resistant coating for added strength made from 100% biodegradable/compostable materials

There are numerous other litter systems or kits that incorporate automated cleaning of the litter box which are not of a 100% biodegradable/compostable structure or do not contain 100% biodegradable/compostable litter. Many disposable designs or inventions are simply non-biodegradable liners or inserts for conventional litter boxes without providing a complete 100% biodegradable/compostable solution.

### DESCRIPTION OF PRIOR ART

Pet litter containers claiming to be disposable with pre-packed litter material have been disclosed in prior art. U.S. Pat. Nos. 5,832,869; 4,164,314; 4,501,226; 4,553,671; 4,648,349; 4,846,105; 5,123,381; 5,249,550; 5,394,834 and 6,487,990 B1 all disclose pet litter boxes, containers and packages for the collection and disposal of pet waste utilizing a litter product and made from cardboard die-cut blanks having a variety Of shapes.

None of the aforementioned prior art patents disclose a true 100% biodegradable/compostable pet litter system or kit having the particular combination of features, designs and accessories to assure a 100% green solution for pet litter maintenance and disposal. The focus of these mentioned patents is based on a disposable litter container only. Some mention biodegradable but none mention a complete 100% biodegradable/compostable litter kit which includes the litter box or container, all natural litter, waste removal scooper and waste disposal bags.

Accordingly, it is the objective of the present invention to not only provide a disposable litter container but also to provide a 100% biodegradable/compostable litter kit solution including the addition of 100% biodegradable/compostable pet litter, a 100% biodegradable/compostable disposable scooper, a 100% biodegradable/compostable false floor to remove contaminated litter away from the pet and a 100% biodegradable/compostable waste removal bag.

Another objective of this invention is to provide a false floor design, which will allow contaminated litter to pass through the clean litter and through the false floor and be held in a waste storage area under the false floor. This false floor design works well with all large particle based natural litter such as 100% natural pine pellets.

Another objective of this invention is to provide a self-contained kit, which includes all of the above-mentioned items, and to include a separator piece to hold the litter in place so the kit has the ability to be shipped in the same container as the litter box itself.

Another objective of this invention is to provide a container that when opened provides adequate depth and space for litter retention in the box while allowing for a holder to hang the disposable scooper and a storage slot for the daily disposal bags.

Another objective of this invention is to provide a 100% green solution for pet owners to assure they are not contributing additional harm to the environment by utilizing a chemical based litter and disposing of litter in plastic bags which can take up to 100 years to completely break down in a land fill.

Another objective of this invention is to provide for a recloseable system, which allows for re-insertion of the separator piece, which will contain the remaining litter and any remaining soiled litter from being released from the box before being disposed of.

Another objective of this invention is for all components within the kit, including the litter to break down in a landfill in as little as 2 months but no longer than 12 months. The key objective of this invention is to minimize the impact on the environment.

Another objective of this invention is to allow for the 100% biodegradable/compostable litter kit to be manufactured in high volume to allow a 100% green solution for pet litter maintenance affordable by all pet owners.

### DESCRIPTION OF THE INVENTION

In accordance with the present invention, there is provided a 100% biodegradable/compostable pet litter system including all natural cat litter, a 100% biodegradable/compostable litter container, a 100% biodegradable/compostable fake floor, a 100% biodegradable/compostable waste scooper and 100% biodegradable/compostable waste disposal bags. The embodiment of a pet litter system or kit with this present design provides for a disposable litter kit made from 100% biodegradable/compostable materials which have the strength and durability to handle daily use as a pet toiletry system for up to 15 days and also can be resealed to allow for easy disposal by the pet owner.

### BRIEF DESCRIPTION OF THE DRAWINGS

FIG. 1—is a flat form of an embodiment of the present invention that when folded would form the 100% biodegradable/compostable litter box for the complete litter system.

FIG. 2—is a design schematic of a false bottom for litter separation that may be used with the litter box in FIG. 1.

FIG. 3—is a design schematic of a top pad or separator piece that may be used with the litter box of FIG. 1 to retain litter during shipment.

FIG. 4—is a design schematic of a 100% biodegradable/compostable litter scoop that is used with the litter box in FIG. 1.

FIG. 5—is a flat form of an embodiment of a master shipment carton that would hold two 100% biodegradable/compostable disposable litter systems or kits for shipment. This component is also 100% biodegradable/compostable.

FIG. 6a—shows a front view of the litter box in the open position with the separator piece in the box along with the scooper. The top lid shows the disposable bags in store in their built in holder.

FIG. 6b—shows a side view of the litter box with the top lid being folded back so it can be locked in place at the rear of the litter box and the built in latch or hanger for the disposable litter scooper.

FIG. 7a—shows a side view of the litter box with the top lid tabs inserted into the back of the litter box bottom for security

FIG. 7b—shows a rear or back plain view of the litter box with the scooper positioned on the hock or latch and the disposable bags held in place by the built in bag retainer slots.

FIG. 8a—shows the full rear or back plain view of the litter box fully assembled

FIG. 8b—shows a front view of the litter box fully open and the removal of the separator piece to expose the biodegradable litter. Removal of the separator plate in this figure readies the litter box for pet use.

### DETAILED DESCRIPTION OF THE PREFERRED EMBODIMENT

The following detailed description is of the best currently contemplated modes of carrying out exemplary embodiments of the invention. The description is not to be taken in a limited sense, but is made merely for the purpose of illustrating the general principles of the invention, since the scope of the invention is best defined by the appended claims.

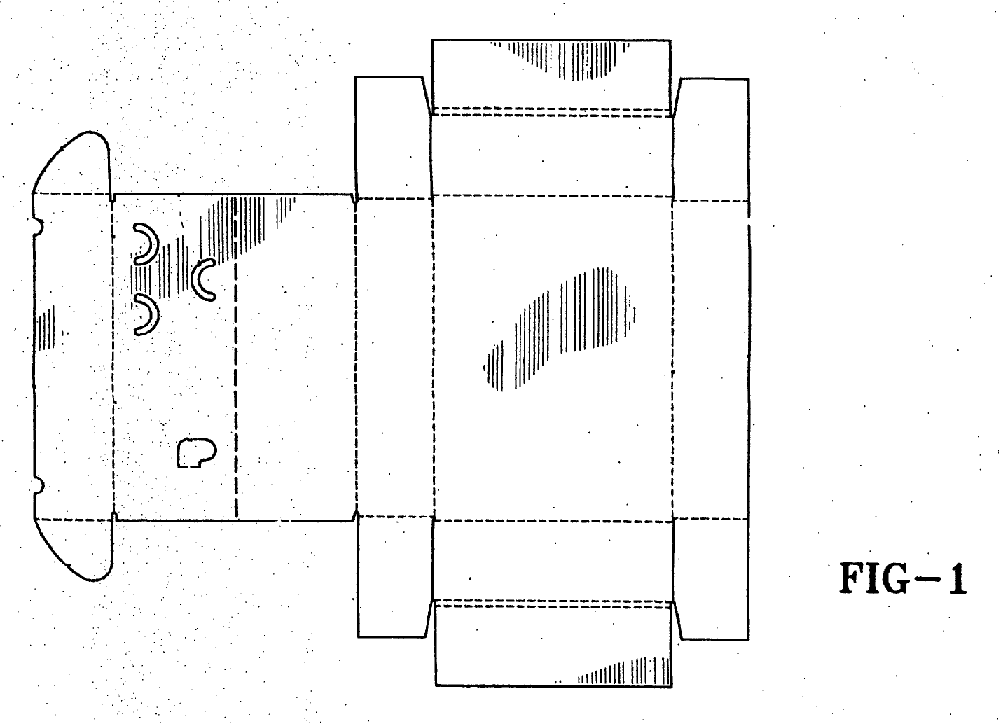

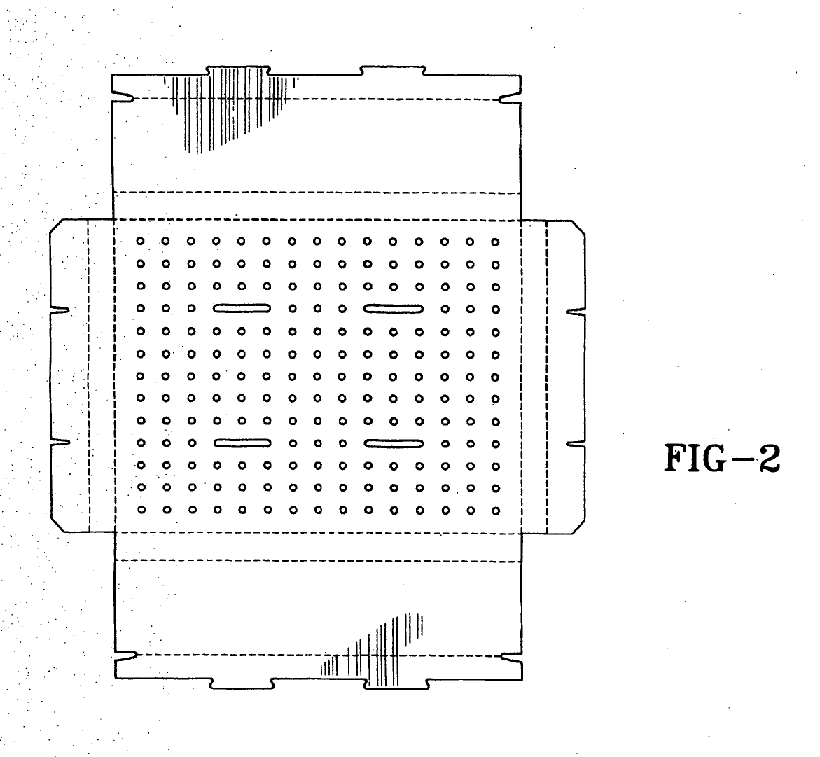

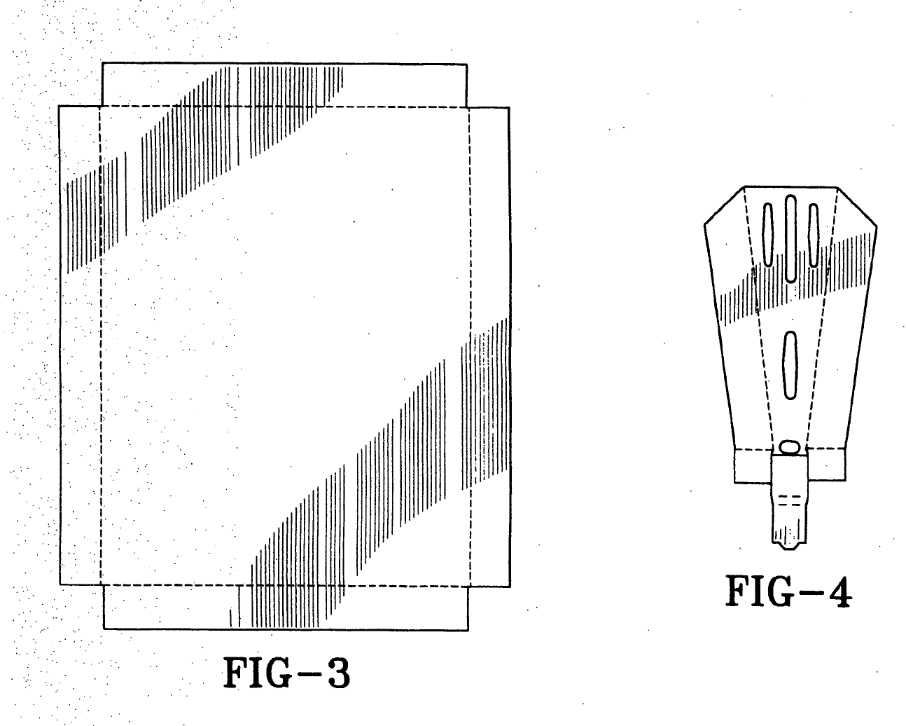

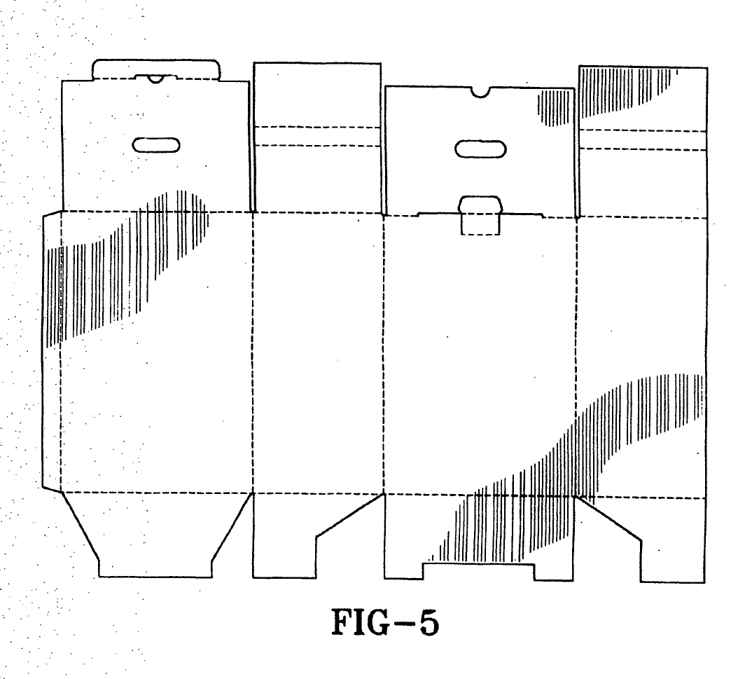

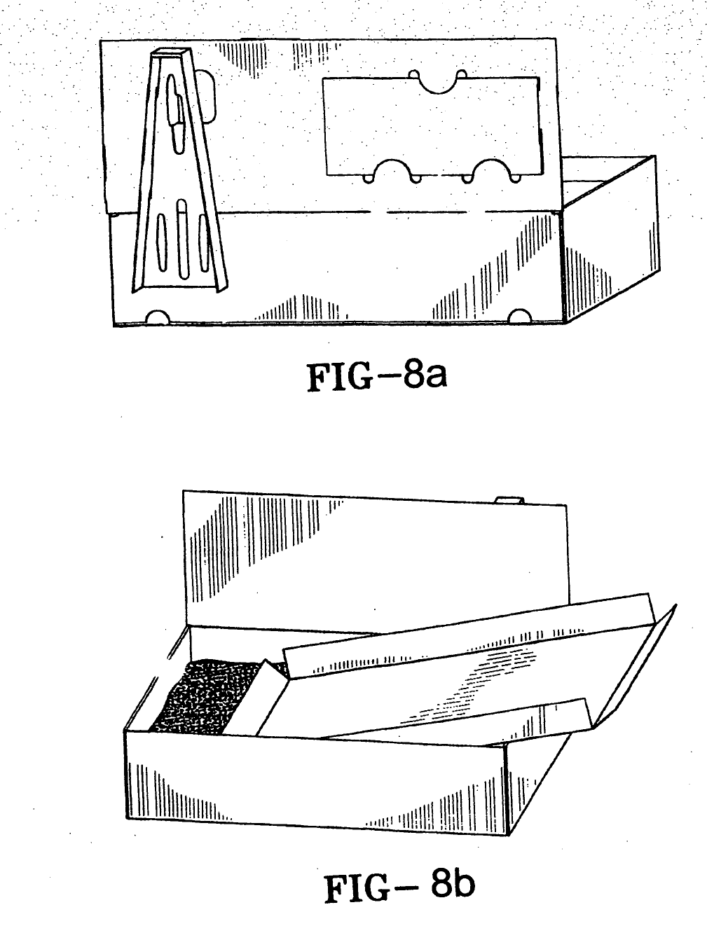

Broadly, an embodiment of the present invention provides for a 100% biodegradable/compostable pet litter system or kit. The 100% biodegradable/compostable litter box (FIG. 1) incorporates a lid to hold the litter kit components in place during shipment. The present invention includes 100% biodegradable/compostable pet litter with the litter system or kit. The perforated 100% biodegradable/compostable false bottom (FIG. 2) may be included in the complete system or kit depending on the 100% biodegradable/compostable litter type used. The embodiment of this present invention is highlighted with 100% biodegradable/compostable pine pellets, which incorporates the use of the specially designed perforated false floor. When the kit includes litter, the addition of the separator piece or top pad (FIG. 3) is inserted to prevent movement of the litter and other kit components during shipment. For the pet litter system to be 100% biodegradable/compostable, the kit includes a scooper (FIG. 4) for soiled litter removal and a supply of disposable bags (FIG. 5) to remove the waste, which is all biodegradable and compostable. In one embodiment, the kit may include 15 bags and a 15-day supply of litter. This can vary depending on the type and amount of 100% biodegradable/compostable litter used in the kit. In the embodiment of this invention, two of the litter kits (FIG. 1) may be included into a shipping container (FIG. 8).

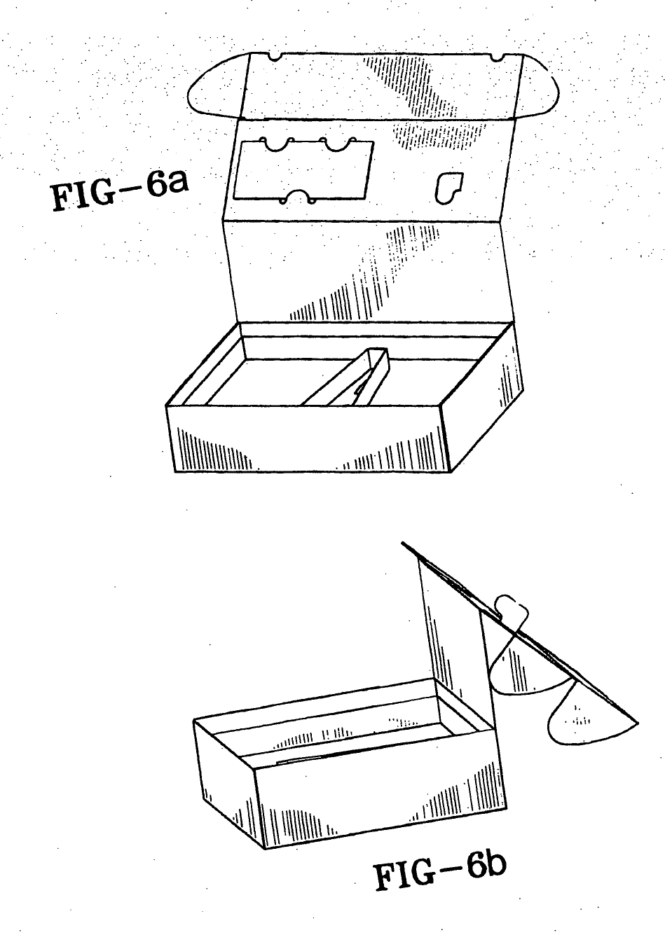

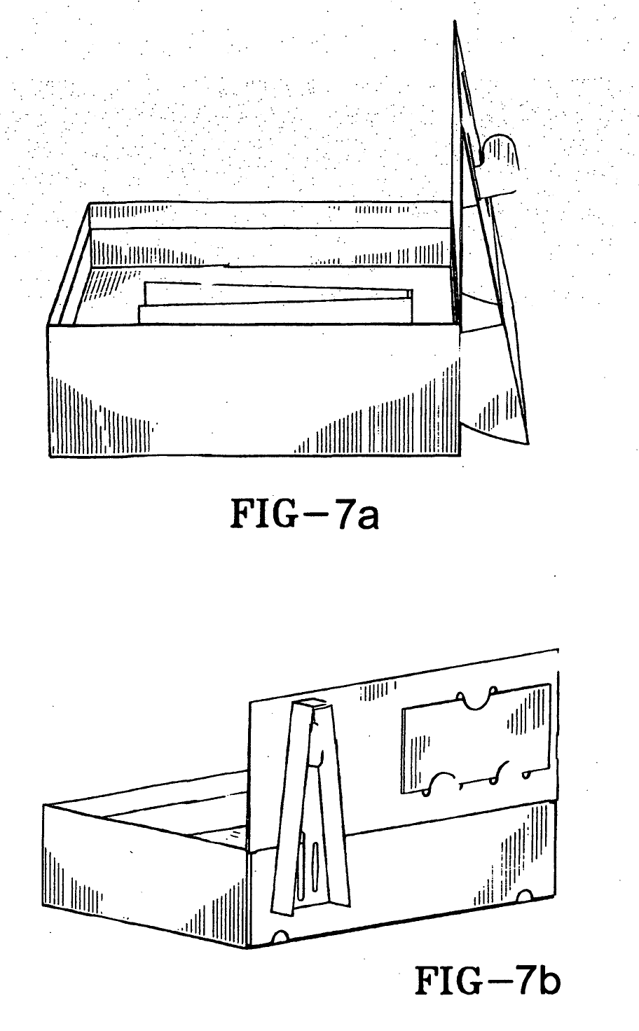

To us the 100% biodegradable/compostable pet litter system, the lid may be opened, folded back and locked into the back of the box using locking flaps on each side (FIG. 6). A tab on the lid may be used to hang the scooper and slots in the lid may be used to hold the disposable bags. The separator piece may be removed to expose the 100% biodegradable/compostable litter.

In the embodiment of this invention the 100% biodegradable/compostable litter used is pine pellets. When the pet urinates on the pine pellets, they break down into sawdust. The perforated false bottom allows this saw dust or soiled waste from cat urine to drop through the perforated false floor to the bottom of the litter box and away from the cat, assuring that the cat always has clean litter. The false bottom also reduces the likelihood that soiled litter remains on the cat's paw and is tracked around the owner's house.

Periodically, preferably daily, the scooper may be used to place solid waste and soiled litter into one of the disposable bags. After the supply of bags has been depleted, the separator piece or top pad may be re-inserted and the scooper placed back in the litter box. The lid may be unfolded and closed. The litter box and remaining contents may then be disposed for recycling or composting. It is recommended that the 100% biodegradable/compostable litter system not be disposed of inside a plastic trash bag. This will prevent the litter kit from properly breakdown compromising the design and invention of a complete 100% biodegradable/compostable pet litter system or kit.

The litter box, the perforated false bottom, the separator piece, the scooper and the shipping box may be manufactured from post-consumer, biodegradable fiberboard or other appropriate material that is tested and verified to be 100% biodegradable/compostable. The disposable bags should also be made from a post-consumer, biodegradable material.

In the embodiment illustrated by the drawings, the litter box may be approximately 18 inches long, 15 inches wide, and 5 inches deep. It will be appreciated that box may have any other convenient dimensions. The litter may be any 100% biodegradable/compostable litter, as in this embodiment, pine pellets, having a depth of approximately 1½ inches. The use of a litter such as pine pellets are biodegradable and may break down into wood fibers or sawdust, that does not need to be scoop as conventional litter does. Rather, the soiled fibers may be sifted away from the clean litter and dropped through the perforated false floor bottom. Other types and depths of 100% biodegradable/compostable litter may also be used.

It should be understood, of course, that the foregoing relates to exemplary embodiments of the invention and the modifications may be made without departing fro the spirit and scope of the invention set forth in the following claims.

I claim:

1. A pet litter system or kit comprising: a box to hold the bet litter;

2. A box lid that, in use, is attachable to the bottom of the litter box on which by the invention has a hook to hold a scooper and a slot to hold disposable bags; and

3. A separator or top pad insert to hold litter and other kit contents in place during shipment;

4. A perforated insert-able or permanent false bottom floor to allow soiled waste to drop through and away from the clean litter;

5. And that the litter box, box lid, separator piece, false bottom, scoop and bags being made from 100% biodegradable/compostable material

6. And that any master shipping carton or any shipping material is made from 100% biodegradable/compostable material
